(19) United States
(12) Patent Application Publication
(10) Pub. No.: US 2009/0275318 A1
(43) Pub. Date: Nov. 5, 2009

(54) Method and apparatus for transferring data between mobile telephones and other digital devices

(76) Inventors: Randy C. Lee, Mountain View, CA (US); James C. Patton, Salinas, CA (US); Yui Kaye Ho, Hong Kong (CN)

Correspondence Address: DAVID LEWIS, 1250 AVIATION AVE., SUITE 200B, SAN JOSE, CA, 95110, US

(21) Appl. No.: 11/105,301

(22) Filed: Apr. 14, 2005

Related U.S. Application Data
(60) Provisional application No. 60/569,110, filed on May 10, 2004.

(51) Int. Cl. H04M 3/00; H04M 1/00

(52) U.S. Cl. 455/418; 455/557

(57) ABSTRACT

The method and apparatus of the present invention provide a means for users to transfer the data contents of a cell phone memory to a PC. The apparatus of the present invention comprises a low complexity digital device having two I/O (Input/Output) connectors, one for the user's cell phone and one for connecting to the PC. Central to the apparatus of the present invention is an Inter-device Data Transfer Processor (IDTP) which contains the necessary hardware and software to automatically move the data contents of a cell phone memory to a PC using a two step process.

This non-provisional utility patent application claims priority filing from provisional application No. 60/569110 filed May 10, 2004.

### BRIEF DESCRIPTION

The subject of this invention relates to the communications industry. Specifically, the present invention is directed to mobile telephones and more particularly to the ability to transfer the data contents of a mobile telephone memory to some other digital device. Examples of such data include phone number directories and pictures, among others.

### BACKGROUND OF THE INVENTION

Mobile telephones have been in existence for some time. Initially, these devices were limited to audio messaging typical of telephony communications. More recently other services and functions have emerged for use on a mobile, or cellular telephones. These services include text messaging, pictures, GPS location and Internet browsing.

One consequence of these emerging services, driven by accelerating technology, is the need for users to update their equipment. This trend has been exacerbated by cellular service providers who offer incentives to upgrade. Of course the reason for this is to encourage the user to spend more time on the air, thus increasing the revenue of the service provider, but the result is that a user will have certain data stored on his/her present cell phone that will need to be transferred to a the new phone or, more likely, have to be reentered.

Although some cellular service providers currently provide a method for accomplishing such a data transfer, the solution is specific to a device and typically performed only at a provider's store. Thus if the user upgrades or changes to a non-compatible device, the transfer method is useless. Each of the plethora of cell phone manufacturers provides unique connections to their phones, both physical and electrical. Thus while a user may buy a newer phone from the same manufacturer, the interconnect method will likely be different, again rendering the data transfer method useless.

Also present in the prior art are solutions that enable a user to backup their cell phone data to the cellular service providers network which over time is very expensive to the consumer because of the repeating monthly service charge and once using the service, locks in the consumer with that particular service provider. Other solutions include software and cable solutions that are PC centric and difficult to use because of the non-standard cell phone driver requirements needed to run software on a PC, for example SnapSync™ from FutureDial, Sunnyvale, Calif.), and other devices such the Mobile Whiz from i. Tech Dynamic Limited, Hong Kong, because of the products limited features, network specific cell phone support (GSM cell phone only), and non-functional form factor. Each of these has limitations. For example, backing up to a network diminishes the portability of the data and requires a network capable cell phone. In some cases, the network that is used is not compatible with others phones or networks, severely limiting viability of data back-up. With the use of network solutions as well as the other solutions above, data portability and ease of use is a problem.

A further problem with the prior art is that there is no way to simply back up the data contained in the cell phone memory. Thus if the user drops the phone and breaks it, or, as is sometimes the case, simply looses the device, all the data contained in the cell phone memory is lost. Contemporary digital devices such as PCs, MP3 players and PDAs all have a method for storing data in an external medium to protect against such exigencies.

Because of the rather large number of cell phone manufacturers, coupled to the even wider variety of interconnect configurations, users who are upgrading or changing equipment are at a distinct economic and functional disadvantage, since they will necessarily have to purchase the requisite accessories as well as the phone. What is needed is a method and apparatus whereby a user can make a single purchase of an accessory that will adapt to a plurality of cell phones, allowing them to reuse the transfer capability again and again thereby providing a significant functional advantage to the consumer.

What would be even more advantageous would be a method and apparatus that allowed the transfer of data from a cell phone to some other digital device, for example a PDA (Personal Digital Assistant) or PC (Personal Computer). In this way the user could maintain current data on a plurality of digital devices without having to use a multitude of interconnect methods. The capability to store the data from a cell phone in an external medium provides the additional advantage of allowing for back up of critical data.

The method and apparatus of the present invention provide a cell phone user with the ability to transfer the data contents of a cell phone to a PC for editing or backup. Several advantages derive from the present invention as discussed in detail below.

### SUMMARY OF THE INVENTION

The method and apparatus of the present invention provide a means for users to transfer the data contents of a cell phone memory to a PC. The apparatus of the present invention comprises a low complexity digital device having two I/O (Input/Output) connectors, one for the user's cell phone and one for connecting to the PC. Central to the apparatus of the present invention is an Inter-device Data Transfer Processor (IDTP) which contains the necessary hardware and software to automatically move the data contents of a cell phone memory to a PC using a two step process.

The process for transferring data from a cell phone to a PC is accomplished in two steps. Which step is accomplished first depends upon whether the data is being transferred from the cell phone to the PC or vice-versa. Because of the automatic nature of the software response of the method of the present invention coupled to the physical configuration of the hardware of the apparatus of the present invention, only one connection may exist at any time.

Assuming that the user wishes to transfer data from his/her cell phone to a PC, the user simply plugs the apparatus of the present invention into his/her cell phone using the appropriate connector. The IDTP senses power from the cell phone and automatically turns on, doing an internal check to see that all functions are operating properly. Once the internal check is complete the self contained software initiates a loop that waits for the user to enter a command via one of a plurality of buttons. For example, the user may depress the Backup button, signaling the self contained software to commence fetching data from the memory of the cell phone. The data are copied from the cell phone memory to the memory of the apparatus where they remain until the user takes some further action.

Once the data from the cell phone are stored in the memory of the apparatus of the present invention, the user disconnects the cell phone and connects the apparatus to a PC, for example by way of a USB connection. Since the IDTP senses that power from the cell phone has been lost, the apparatus of the present invention shuts down. However, upon connecting to the PC, the IDTP again senses power and accomplishes the power on steps as stated above.

Since the data from the cell phone were stored in the non-volatile memory of the apparatus of the present invention, they are now ready to be transferred to the PC. The user simply launches an application program on the PC and follows the procedures for operation of the program to transfer the data from the memory of the apparatus to the memory of the PC. The application program contains the necessary functionality to edit data. By way of example, a user can modify existing data, add new data or delete existing data.

Once done the user reverses the process, updating the memory of the apparatus and then updating the cell phone memory. In this way the user may transfer data contents from a cell phone to a PC using a single apparatus and alternately connecting the apparatus to the cell phone or the PC.

As can be seen, the method and apparatus of the present invention offer a distinct economic and efficient benefit to the user. This and other features and advantages of the present invention are discussed in detail below in conjunction with the drawings and figures attached.

### BRIEF DESCRIPTION OF THE DRAWINGS

FIG. 1: is a block diagram of the preferred embodiment of the apparatus of the present invention.

FIG. 2: provides a generic interface schematic between the apparatus of the present invention and a user's cell phone.

FIG. 3A-3E: provide a detailed flow chart of the cell phone operations associated with the method of the present invention.

FIG. 3F-3H: provide a detailed flow chart of the alternate digital device operations associated with the method of the present invention.

FIG. 4: provides the details of the user interface to the application program of the present invention running on the alternate digital device.

FIG. 5: provides the details of the user prompt screen of the application program of the present invention running on the alternate digital device.

### DETAILED DESCRIPTION OF PREFERRED EMBODIMENTS

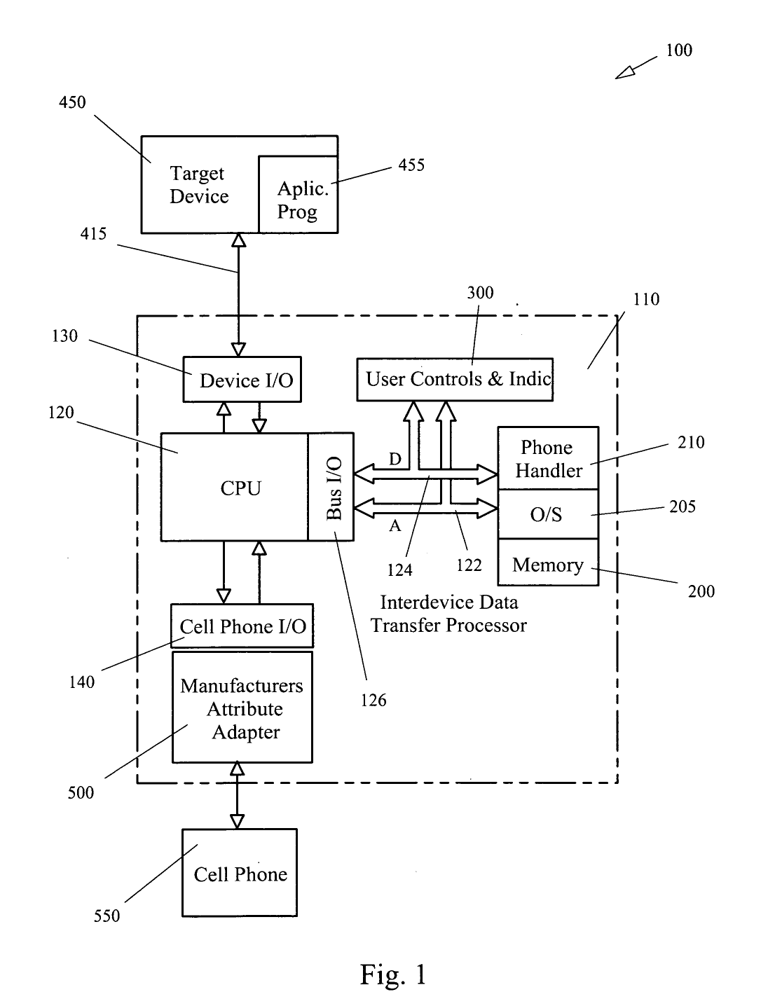

As described briefly above, the method and apparatus of the present invention provide a user with the ability to transfer the data contents of the memory of a cell phone to another cell phone or to any of a plurality of other target digital devices. FIG. 1 is a block diagram 100 of a preferred embodiment of the apparatus of the present invention.

An IDTP 110 contains a CPU 120, Memory 200 and User Controls 300, Cell Phone I/O 140 and Device I/O 130. Note that Memory 200 is actually comprised of two separate memories: flash memory containing phone book data and program memory containing the O/S (Operating System) software 205 and Phone Handler software 210. Also note that while Memory 200 is shown as a separate item, it is actually part of the CPU integrated circuit device. User Controls 300, Memory 200 and CPU 120 communicate via Address Bus 122 and Data Bus 124. As with the Bus I/O 126, these operate in the conventional manner thus are not discussed in detail to aid in clarity, however, lack of such a detailed discussion is not an implied limitation on the scope of the invention.

User Controls 300 consist of a series of buttons, for example, an Update Button and a Backup button. User Indicators (not shown) consist of a series of LEDs (Light Emitting Diodes) that inform the user of the status of the various steps in the transfer process. The reader will recognize that more or fewer buttons/indicators may be present without departing from the spirit of the invention, thus the scope of the invention is limited only by the claims.

Cell Phone I/O 140 connects to Manufacturer's Attribute Adapter (MAA) 500 and then to the user's cell phone 550 via the normal cell phone I/O connector. MAA 500 is contained within IDTP 110. The purpose for separating the Cell Phone I/O 140 and the MAA 500 is to allow a plurality of MAA modules to be interfaced with a single, universal Cell Phone I/O. In the preferred embodiment, MAA 500 is a small printed circuit board that connects to the Cell Phone I/O via well understood connector means. One advantage of the apparatus of the present invention is the ability for the manufacturer to adapt to a wide variety of cell phones simply by changing the MAA 500.

Device I/O 130 connects to Target Device 450 via interconnect 415. In a preferred embodiment of the apparatus of the present invention the connection between the Device I/O 130 and the Target Device 450 is made using a USB (Universal Serial Bus) scheme. It will also be understood, however, that the interconnect could be any of a multitude of interconnects, for example, a serial, parallel, infrared (IR) or even a wireless connection such as 802.11b without departing from the spirit of the invention, thus the use of the USB connection should not be read as a limitation on the scope of the invention. Thus another advantage of the present invention is that the user has the ability to connect to a wide variety of target devices simply by changing the Device I/O Adapter 400.

Turning now to Target Device 450, in a preferred embodiment of the present invention the target device is a PC. Contained within Target Device 450 is Application Program 455. As described in detail below, this program allows the user to manipulate data transferred from or destined for a cell phone. While the target device in the preferred embodiment is a PC, it will be recognized that other target devices could be used as long as the Application Program 455 is able to execute on the target device, thus the use of a PC in the preferred embodiment should not be viewed as a limitation on the scope of the invention.

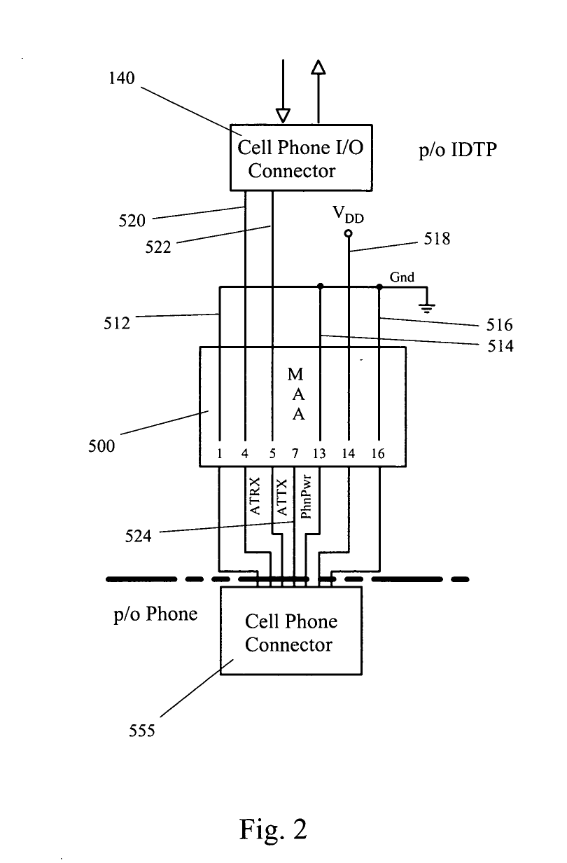

FIG. 2 provides the details of the interconnection between a cell phone and the IDTP of FIG. 1. While the details of the MAA 500 will vary from manufacturer to manufacturer, the operational concept is the same. In this case, the MAA 500 is configured for a Motorola (Motorola, Inc., Schaumburg, Ill.) cell phone 555. Phone Power 524 on pin 7 is used to monitor the state of the battery in the cell phone. Six other connections are made from the MAA 500 to the Cell Phone I/O 140 for this instantiation. Power is passed to the apparatus of the present invention via Vdd signal 518 appearing on pin 14. Ground is applied via pins 1, 13 and 16, signals 512, 514 and 516 respectively. The active data transfer signals are ATRX 520 and ATTX 522 appearing on pins 5 and 4 respectively. Other MAAs may or may not use the exact pin configuration as the Motorola MAA but the functions performed by the various signals are identical.

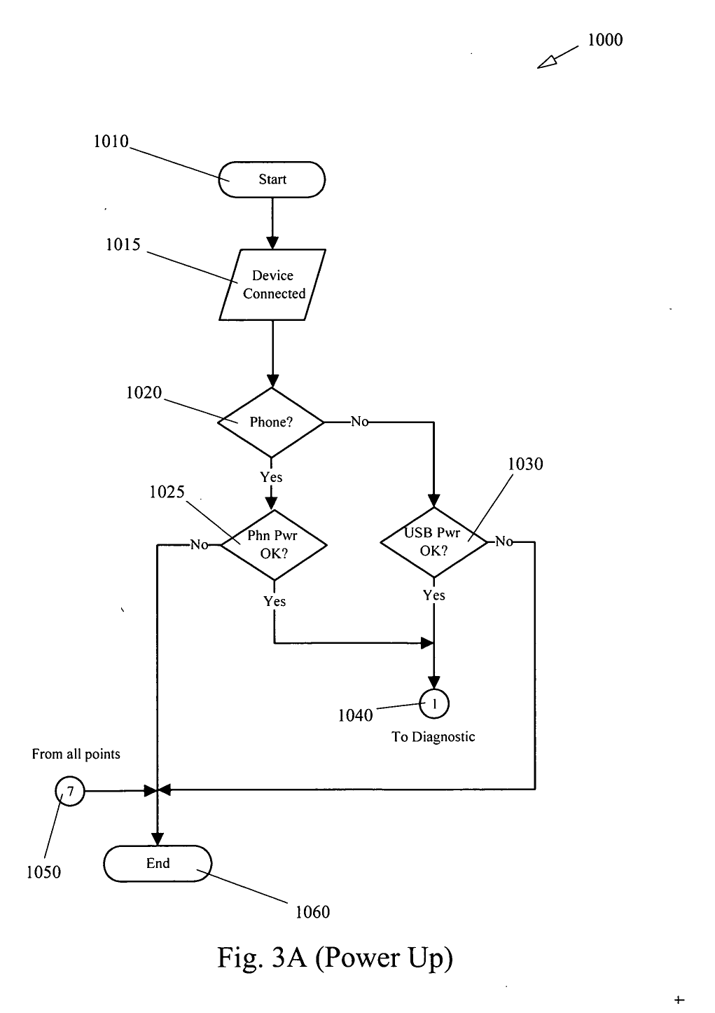

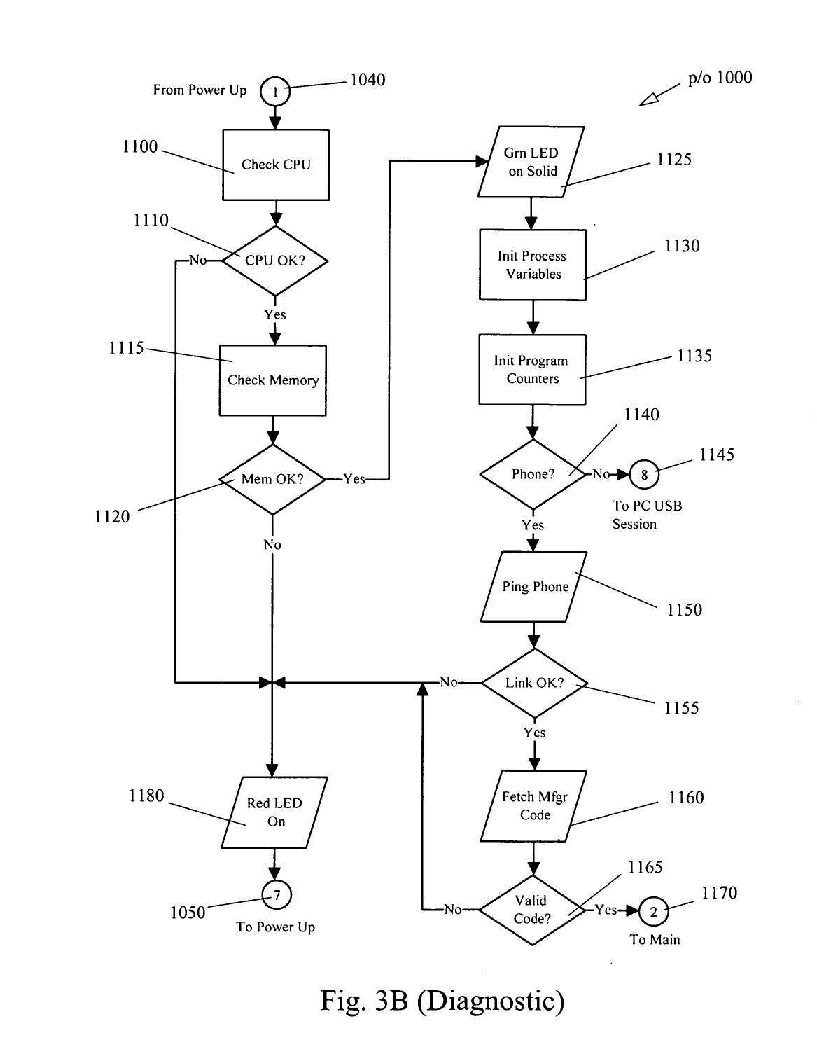

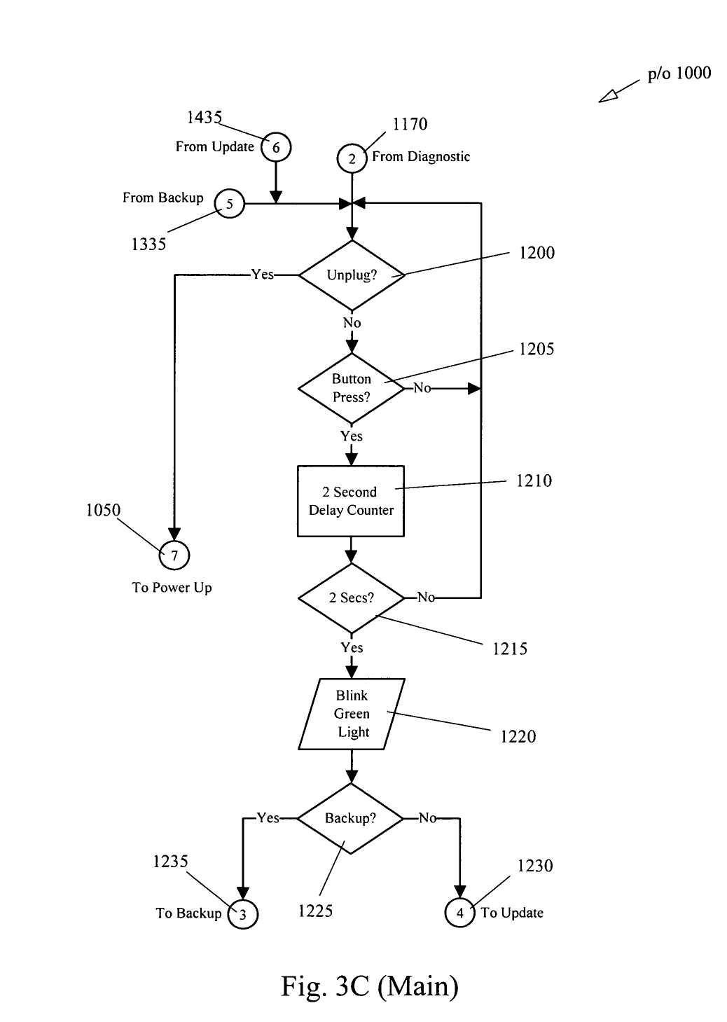

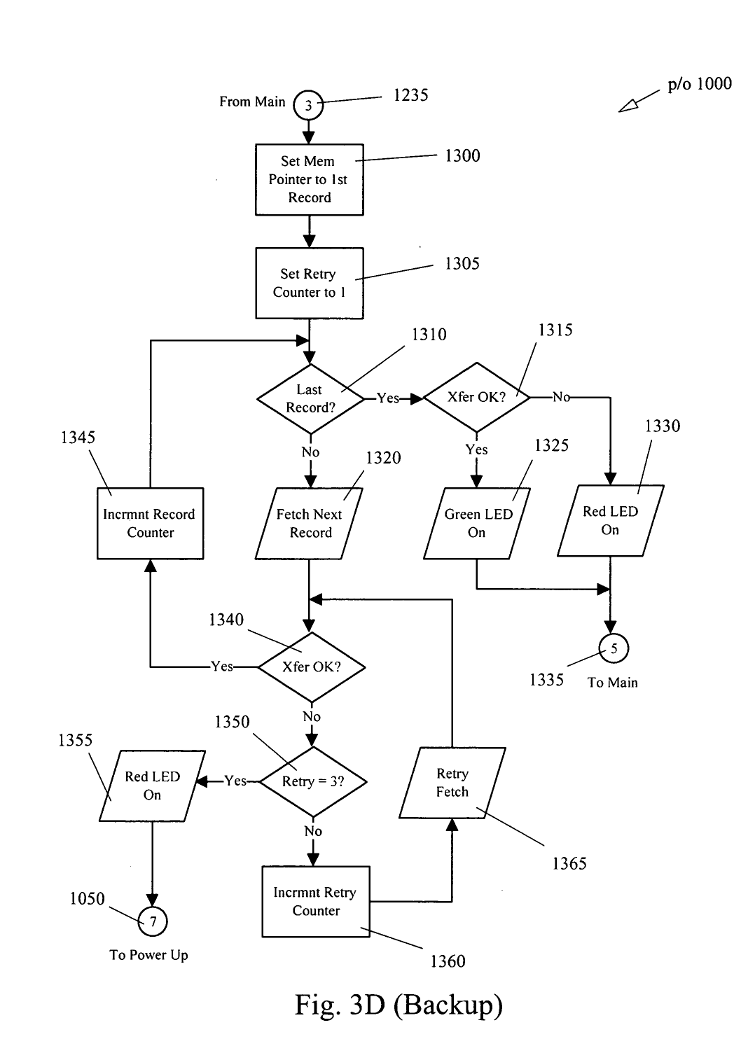

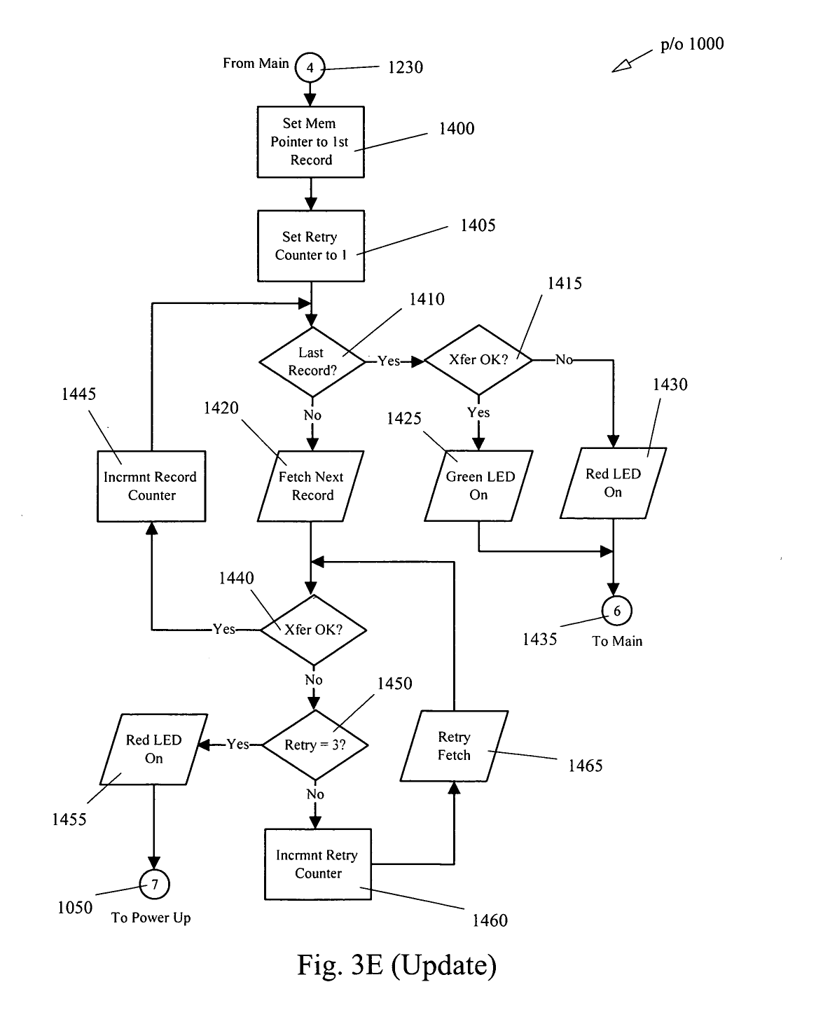

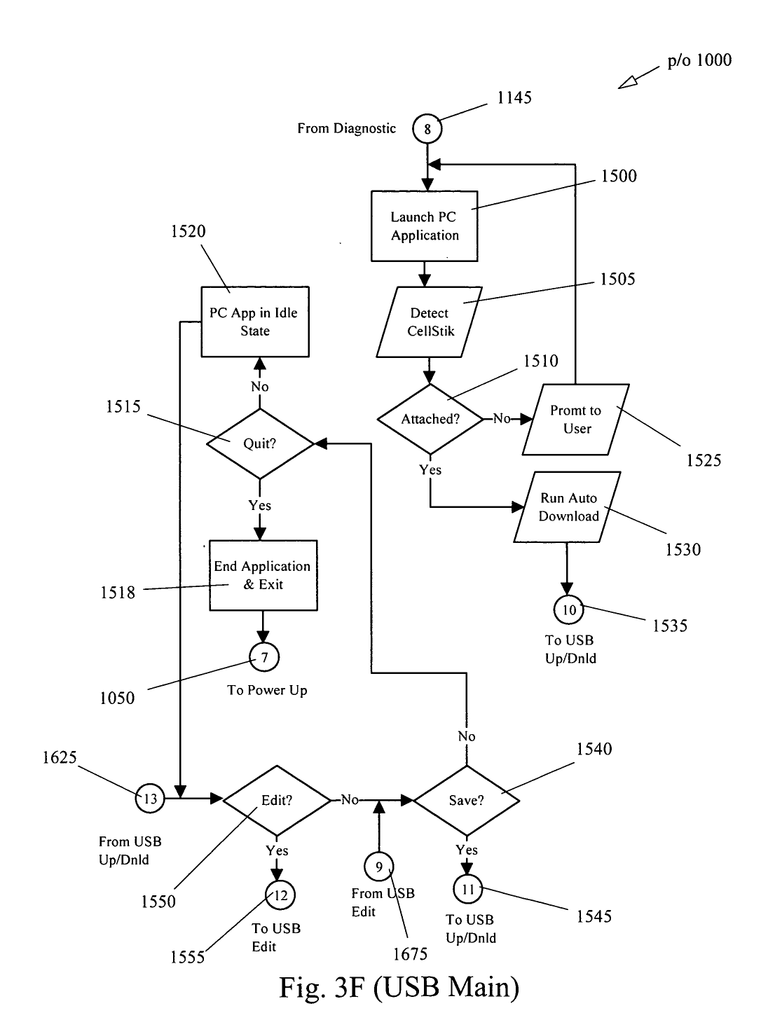

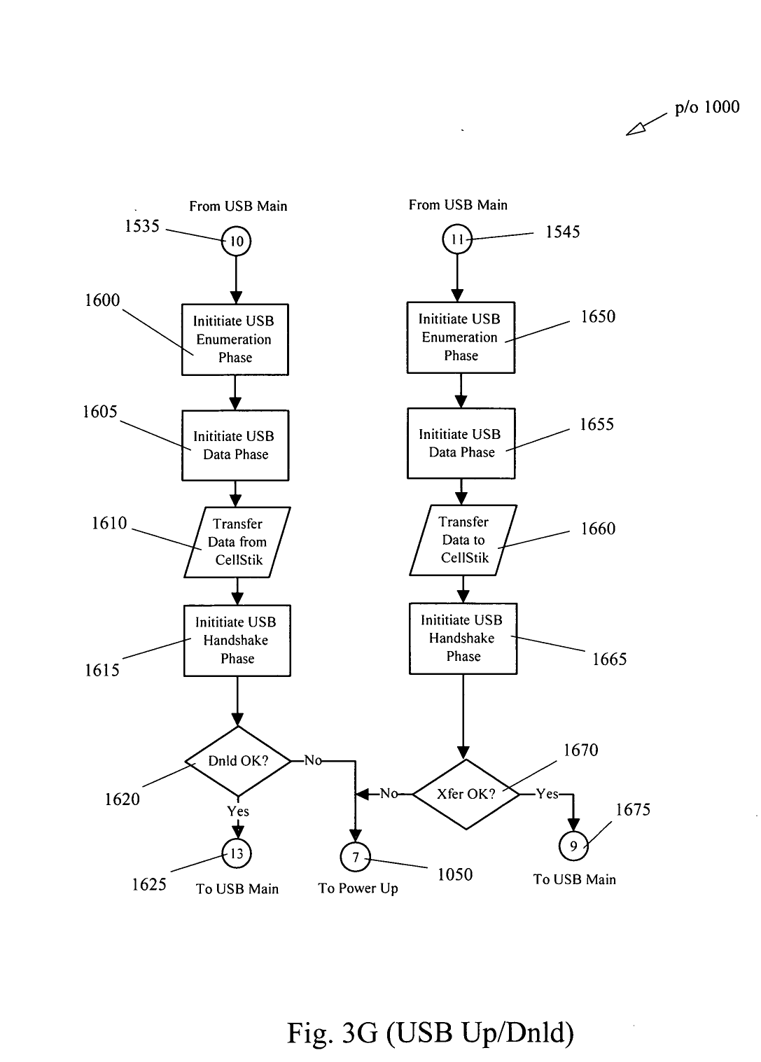

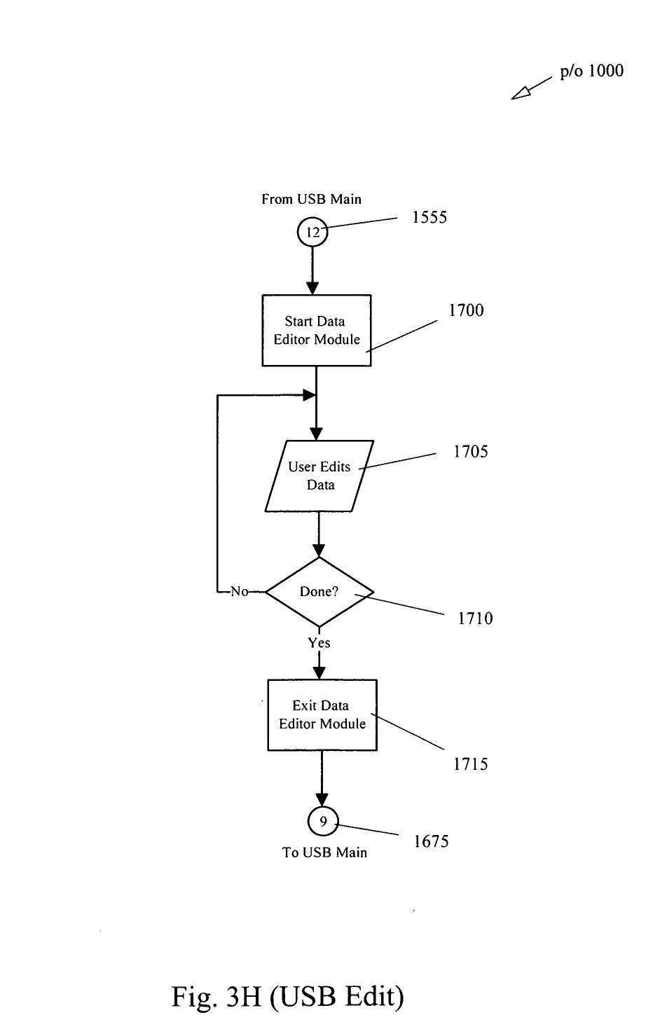

Referring to FIG. 3, a detailed flowchart 1000 of the method or the present invention is presented. FIGS. 3A through 3E provide the details of the cell phone to inventive apparatus process while FIGS. 3F through 3H provide the details of the inventive apparatus to target device process. For the discussion that follows it will be assumed that the target device is a PC. Also, connectors having the same reference designator, for example, connector 7 1050 in FIG. 3A, are the same physical point.

Beginning with FIG. 3A, the process is entered at the Start step 1010. At Device Connected step 1015 the user has attached a cell phone to the apparatus of the present invention. At Phone? decision 1020 the method of the present invention determines if the device connected is a phone or some other target device. If it is not a phone, the process determines if the power from the target device is good at USB Power OK? decision 1030. If the power is good the process proceeds to the diagnostic routine via connector 1 1040. If the supplied power is not good, the process ends at the End step 1060.

If the device connected at 1015 is a phone, the process determines if the power from the cell phone is good at Phone Power OK? decision 1025. If the power is good the process proceeds to the diagnostic routine via connector 1 1040. If the supplied power is not good, the process ends at the End step 1060. Several circumstances will cause the process to end at other points in the flow, thus connector 7 1050 attaches to the End step 1060 ending the process.

FIG. 3B presents the Diagnostic routine of the method of the present invention. The Diagnostic routine is entered via connector 1 1040. At Check CPU step 1100 the CPU accomplishes the necessary internal checks to ensure that the apparatus is operational. For the preferred embodiment the CPU is a DC6088 from DragonChip Ltd., Hong Kong, China, however it will be recognized that other CPUs could be used without departing from the spirit of the invention thus the use of this particular device should not be read as a limitation on the scope of the invention. Since the self check is accomplished in the customary manner no detailed discussion is provided here.

After the CPU check is completed the CPU OK? decision 1110 is executed. If the self check failed the No branch is followed causing the red LED to illuminate at Red LED On step 1180. The process then passes to the End step (1060 of FIG. 3A) via connector 7 1050. If the self check passed the Check Memory step 1115 is accomplished, followed by the Memory OK? decision 1120. If the memory check failed the No branch is followed causing the red LED to illuminate at Red LED On step 1180. The process then passes to the End step (1060 of FIG. 3A) via connector 7 1050. If the memory check was successful the transfer process is ready to execute and flow passes to the Grn LEDs on Solid step 1125. This step is done to ensure that all user indicators are off prior to the start of any data transfers.

At Initiate Process Variables step 1130 the software variables associated with the transfer process are set to their initial values and at Initiate Program Counters step 1135 the various event counters are set to their initial values. These include but are not limited to such variables as memory location pointers and loop counters. Those familiar with the art will recognize that such variables/counters are required for proper operation of a software program. Since these variables and counters are common and used in the customary fashion they are not discussed in detail with the exception of those used specifically for the data transfer operations.

At Phone? decision 1140 the method of the present invention determines if the device attached to the apparatus is a cell phone. If it is not, the No path is followed to the USB application program running on the target device via connector 8 1145. This part of the process is discussed in detail below in conjunction with FIGS. 3F through 3H. If the attached device is a cell phone the Yes path is followed and the communication path to the cell phone is checked at Ping Phone step 1150. If the link failed, the No path is followed to Red LED On step 1180 and the process ends via connector 7 1050.

If the communication link to the cell phone passed, the Yes path is followed to the Fetch Manufacturer's Code step 1160. The code is checked at Valid Code? decision 1165. This step is used to determine if the cell phone connected to the apparatus of the present invention is valid. If not, the No path is followed to Red LED On step 1180 and the process ends via connector 7 1050. If the code is valid, the Yes path passes control of the process to the Main routine in FIG. 3C via connector 2 1170.

Turning now to FIG. 3C, the Main routine of the method of the present invention is shown. Entry to this routine may be from three places: from a successful Backup via connector 5 1335, from a successful Update via connector 1435 or from the Diagnostic via connector 2 1170. Regardless of how the routine is entered the process proceeds to the Unplug? decision 1200 where the method determines if the user has unplugged the cell phone. If the cell phone has been disconnected power is lost and the process transfers to the Power Up routine via connector 7 1050 and then to the End step 1060 of FIG. 3A.

If a cell phone is still attached, the Button Press? decision 1205 is entered. Here the method of the present invention determines if the user has pressed one of the function buttons on the apparatus of the invention. If no buttons have been pressed, the process follows the No path and returns to the Unplug? decision 1200. The process continues in this loop until the user takes some action.

If the user has pressed a button the process enters the 2 Second Delay Counter step 1210 where the process waits two seconds and then proceeds to the 2 Seconds? decision 1215. If two seconds has not passed the process loops back to the 2 Second Delay Counter step 1210 and reenters the 2 Seconds? decision 1215. The process will loop on these steps until two seconds have passed at which time the Yes path will be followed causing the process to enter the Blink Green Light step 1220. The purpose of the two second loop is to de-bounce the button press. The green LED is flashed so that the user receives visual feedback that the button press was successful.

Once the green LED is flashing the process enters the Backup? decision 1225. Here the method of the present invention determines which of the two buttons have been pressed. If the Update button has been depressed the No branch will be followed leading to the Update routine via connector 4 1230. Conversely, if the Backup button has been depressed the Yes path is followed leading to the Backup routine via connector 3 1235.

Referring to FIG. 3D, assume now that the user has depressed the Backup button and that the Yes path has been followed leading to the Backup routine via connector 3 1235. Note that for the following discussion the cell phone being used is not a GSM (Global System for Mobile communications) type phone. This is noted because some phones, such as those used in GSM systems typically use SIM (Subscriber Identity Module) for storage of user data within the cell phone. The method of the present invention is able to determine which type of phone is being used and thus reads and writes to the correct memory. Since the determination of and the actions associated with data transfer to and from SIM memory is the same as to any other memory, a detailed discussion is not included here. Lack of a detailed discussion of the transfer to each available type of memory should not be read as a limitation on the scope of the invention.

The Set Memory Pointer to 1^{st} Record step 1300 ensures that the data backup will start with the first record in the cell phone memory. Next the process enters the Set Retry Counter to 1 step 1305 resets the retry counter to the proper value to begin the data transfer. At Last Record? decision 1310 the method of the present invention determines if the most recently transferred record is the last record in the cell phone memory. If it is not, the No path is followed leading to the Fetch Next Record step 1320. Next the process enters the Transfer OK? decision 1340 to determine if the data in the currently transferred record was passed correctly. While not shown for clarity, this is accomplished using contemporary methods.

If the record was transferred successfully the record counter is incremented at Increment Record Counter step 1345 and the process returns to the Last Record decision 1310. This loop is repeated until all records have been transferred. Once the last record has been passed the Yes path out of the Last Record decision 1310 is followed leading to the Transfer OK? decision 1315. This decision is used to determine that all records have been successfully passed. If they have, the Yes path leads to the Green LED On step 1325 and then returns to the Main routine via connector 5 1335. The green LED on solid informs the user that the transfer operation was successful. If all the records were not successfully transferred the No path is followed out of Last Record decision 1315. In this case the red LED is turned on at Red LED On step 1330 informing the user that a problem exists with the transfer. Again the process returns to the Main routine via connector 5 1335.

Returning to Transfer OK? decision 1340, and assuming that a particular record did not pass successfully, the No path leads to the Retry=3? decision 1350. If the retry count has not exceeded three, the retry counter is incremented at Increment Retry Counter 1360 and the record is again fetched at Retry Fetch step 1365. From here the process returns to the Transfer OK? decision 1340 to determine if the record passed successfully on the most recent try. This loop repeats three times. If the record fails to pass correctly after three tries the Retry=3? decision 1350 yields a true result sending control out the Yes branch to the Turn Red LED On step 1355. Since there exists a fatal result, the method of the present invention passed control to the End step 1060 in FIG. 3A via connector 7 1050.

Referring now to FIG. 3E, assume that the user has depressed the Update button and that the Yes path has been followed leading to the Update routine via connector 4 1230. The Set Memory Pointer to 1^{st} Record step 1400 ensures that the data update will start with the first record in the cell phone memory. Next the process enters the Set Retry Counter to 1 step 1405 resets the retry counter to the proper value to begin the data transfer. At Last Record? decision 1410 the method of the present invention determines if the most recently transferred record is the last record in the cell phone memory. If it is not, the No path is followed leading to the Fetch Next Record step 1420. Next the process enters the Transfer OK? decision 1440 to determine if the data in the currently transferred record was passed correctly. While not shown for clarity, this is accomplished using contemporary methods.

If the record was transferred successfully the record counter is incremented at Increment Record Counter step 1445 and the process returns to the Last Record decision 1410. This loop is repeated until all records have been transferred. Once the last record has been passed the Yes path out of the Last Record decision 1410 is followed leading to the Transfer OK? decision 1415. This decision is used to determine that all records have been successfully passed. If they have, the Yes path leads to the Green LED On step 1425 and then returns to the Main routine via connector 6 1435. The green LED on solid informs the user that the transfer operation was successful. If all the records were not successfully transferred the No path is followed out of Last Record decision 1415. In this case the red LED is turned on at Red LED On step 1430 informing the user that a problem exists with the transfer. Again the process returns to the Main routine via connector 6 1435.

Returning to Transfer OK? decision 1440, and assuming that a particular record did not pass successfully, the No path leads to the Retry=3? decision 1450. If the retry count has not exceeded three, the retry counter is incremented at Increment Retry Counter 1460 and the record is again fetched at Retry Fetch step 1465. From here the process returns to the Transfer OK? decision 1440 to determine if the record passed successfully on the most recent try. This loop repeats three times. If the record fails to pass correctly after three tries the Retry=3? decision 1450 yields a true result sending control out the Yes branch to the Turn Red LED On step 1455. Since there exists a fatal result, the method of the present invention passed control to the End step 1060 in FIG. 3A via connector 7 1050.

Returning to FIG. 3B, Diagnostic, and looking again at the Phone? decision 1140, recall that the preceding discussion centered on a user either updating or backing up data contained in a cell phone. Now assume that the memory of the apparatus of the present invention has successfully transferred data from the user's cell phone and that the user is ready to move that data to a PC. In this case the No path is followed out of the Phone? decision 1140 and the process moves to FIG. 3F, USB Main, via connector 8 1145.

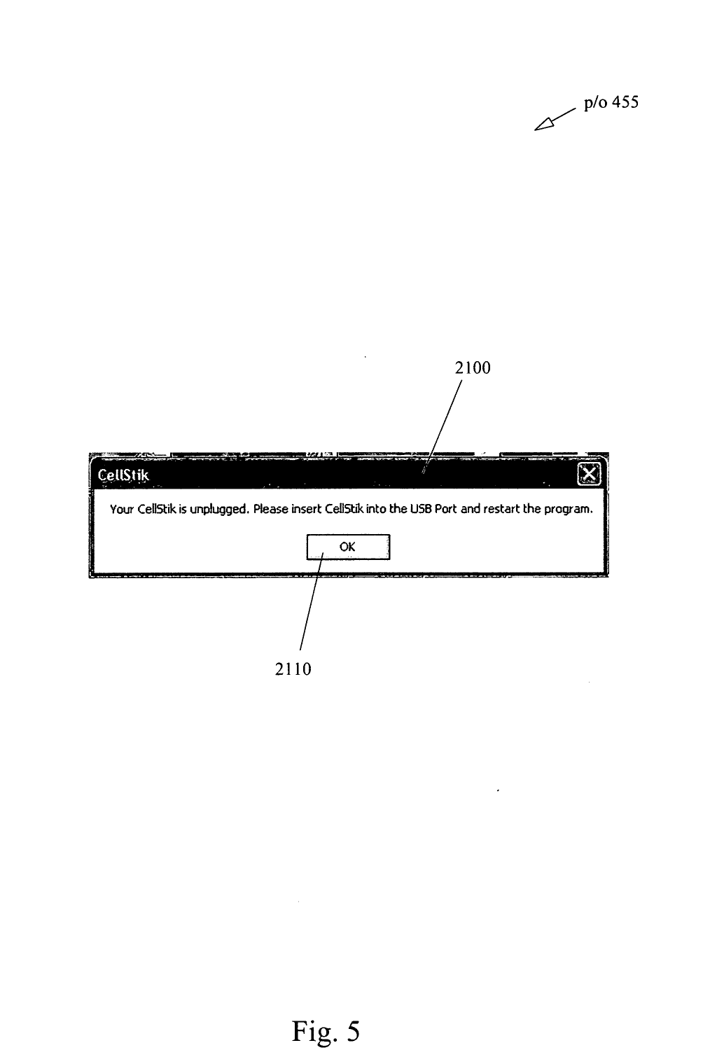

In FIG. 3F the process has entered via connector 8 1145 where the user has started the PC resident application program (455 of FIG. 1) at Launch PC Application 1500. At Detect CellStik step 1505 the application program searches for a USB memory device. The Attached? decision 1510 is used to determine if the user has attached such a device to an active USB port on the PC. If no device is attached, the No path is followed leading to the Prompt User step 1525. Here the application program posts a message to the user to take action as discussed below in conjunction with FIG. 5. Generally, the application program waits for the user to acknowledge the prompt, then quits. After the user attaches a memory device to the PC, the application program is restarted.

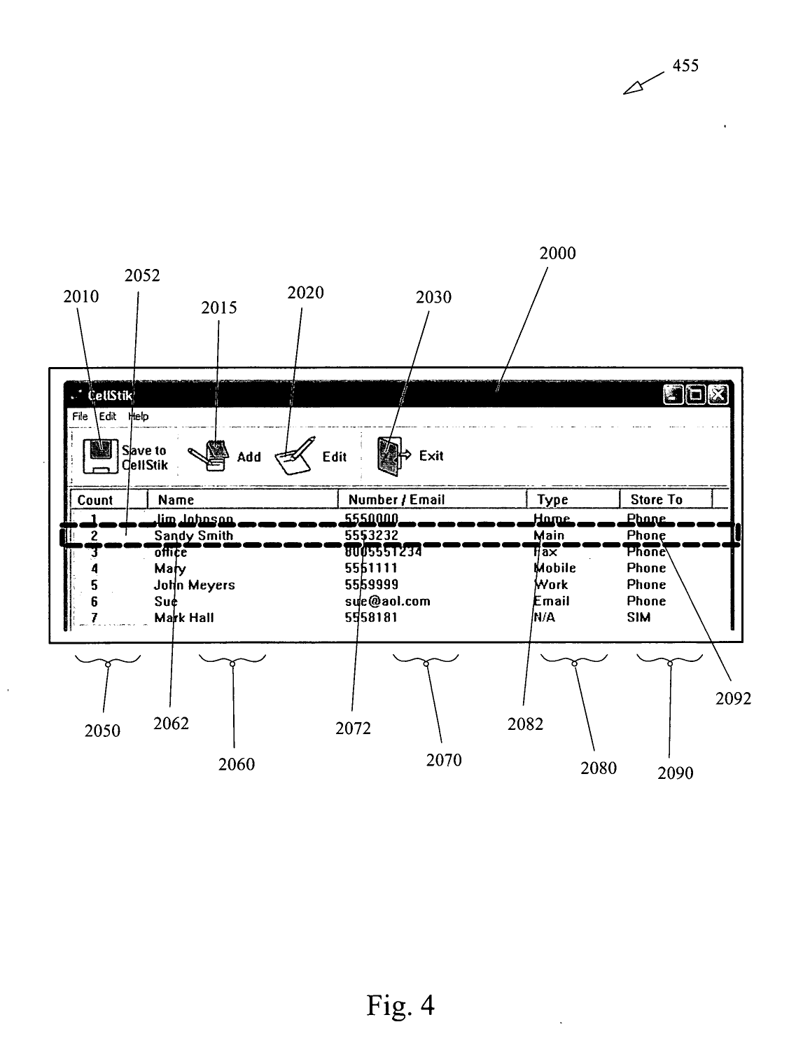

Again looking at the Attached? decision 1510 and assuming that the apparatus of the present invention is properly connected to an active USB port on the PC, the Yes path is followed sending control of the process to the Run Auto Download step 1530. The process advances to the USB Upload/Download routine, FIG. 3G, via connector 10 1535 discussed in detail below. A further advantage of the present invention is that as soon as the user attaches the apparatus and launches the application program on the PC, the data that were transferred from the cell phone to the memory of the apparatus are automatically transferred to the temporary program memory of the PC in a user friendly and efficient manner. These data are then used to populate the fields of the application program screen discussed in conjunction with FIG. 4 below.

For now assume that the auto download has been successful. The process returns to the Edit? decision 1550 via connector 13 1625. This step is required because the initial download is automatic. Once the download is complete the user decides whether to edit the data or to execute an upload of modified data. If the user does not wish to edit the data, control passes to the Save? decision 1540 and then via the No branch the flow proceeds to the Quit? decision 1515. If the user does wish to edit the data, the process enters the USB Edit routine, FIG. 3H, via connector 12 1555.

At the Quit? decision 1515 the application program determines if the user wishes to exit the program and end the transfer session. If the user does wish to exit the Yes path is followed leading to the End Application & Exit step 1518 and then to the End step 1060 of FIG. 3A via connector 7 1050. If the No path has been followed out of the Quit? decision 1515 the user does not wish to exit the application program and must take some action. The process enters the PC Application in Idle State step 1520 and then passes to the Edit? decision 1550. If the user does not wish to edit the data control passes to the Save? decision 1540. If the user does not wish to upload data to the apparatus at this time control passes again to the Quit? decision 1515 via the No path. The process continues to loop in this way until the user takes some action.

Looking at FIG. 3H, the process enters the Edit function at connector 1555 from the Edit? decision 1550 in FIG. 3F. The data editor module is started at Start Data Editor Module step 1700. The data editor module is a general purpose text editing function well known to those of skill in the art and is thus not discussed in detail here to aid in clarity. However, lack of a detailed discussion should not be read as a limitation on the scope of the invention. At User Edits Data step 1705 the user accomplishes any modifications to the data. Then, at Done? decision 1710 the user indicates whether or not the edit task is complete. If not, the No path is followed leading back to the editing task. The process will loop in this manner until the user chooses the Yes path out of Done? decision 1710 at which time the editor module is exited at Exit Data Editor Module step 1715. Process control returns to the Upload? decision of FIG. 3F via connector 1675.

Returning to FIG. 3F, and assuming the user has ended an editing session, the flow enters at connector 9 1675 and passes to the Save? decision 1540. This flow is used because it is likely that after the user has completed a data edit the next step will be to upload the modified data to the apparatus of the present invention. Supposing that the user does wish to upload the modified data, the Yes path out of the Save? decision 1540 is followed leading to the USB Upload/Download routine, FIG. 3G via connector 1545.

Referring now to FIG. 3G, USB Upload/Download routine, and assuming that the user has selected the Yes path out of the Upload decision 1540 of FIG. 3F, the process enters via connector 1545 and passes to the Initiate USB Enumeration Phase step 1650. Once complete the process leads to the Initiate USB Data Phase step 1655 and then to the actual data transfer at Transfer Data to CellStik step 1660. When the data transfer is complete the Initiate USB Handshake Phase step 1665 is executed to verify that an error free data transfer has occurred. Note that the precise details of the data transfer are not discussed since the Universal Serial Bus protocol is well documented and is known in the art.

At Transfer OK? decision 1670 the method of the present invention determines that the data were transferred successfully. If not the No path is followed leading to connector 7 1050 and then to the End step 1060 of FIG. 3A. If the transfer was successful flow passes back to the USB Main routine via connector 9 1675.

Looking now at connector 10 1535, and recalling that at the Run Auto Download step 1530 of FIG. 3F, process control passed to the download function in FIG. 3G. The process enters the download function via connector 1535 and passes to the Initiate USB Enumeration Phase step 1600. Once complete the process leads to the Initiate USB Data Phase step 1605 and then to the actual data transfer at Transfer Data From CellStik step 1610. When the data transfer is complete the Initiate USB Handshake Phase step 1615 is executed to verify that an error free data transfer has occurred. Note that the precise details of the data transfer are not discussed since the Universal Serial Bus protocol is well documented and is known in the art.

At Download OK? decision 1620 the method of the present invention determines that the data were transferred successfully. If not the No path is followed leading to connector 7 1050 and then to the End step 1060 of FIG. 3A. If the transfer was successful flow passes back to the USB Main routine via connector 13 1625.

FIG. 4 provides a view of the user interface screen 2000 for the PC application program 455. The overall appearance of the screen 2000 is that of the well recognized Microsoft Windows operating system. Microsoft and Windows are trademarks of Microsoft Corporation, Redmond, Wash. The Save to CellStik icon 2010 is used to initiate transfers of data from the PC to the apparatus of the present invention. Recall that no action is required by the user to download data from the apparatus as this function occurs automatically upon attachment to an active USB port and launching of the application program.

The Add icon 2015 is used to add new data to the data listing to be saved to the apparatus of the present invention. Clicking on this icon activates the edit function and adds a new line to the bottom of the data list. Clicking on the Edit icon 2020 allows the user to edit existing data in the data list. The required user actions are common to editing methods and are not discussed in detail. However, it will be recognized that such actions as mousing, key entry and the like are used in the customary way. The Exit icon 2030 is used to exit the PC application and end the transfer of data to the apparatus.

The fields of the data list are comprised of a record Count 2050, Name 2060, Number/Email 2070, Type 2080 and Store To 2090. Looking at line two in the data list, an example of a complete data record is shown by the dotted line. The record count 2052 for this entry is 2. The data represent a user named Sandy Smith 2062 with a phone number of 5553232 2072. This particular phone number has a type of Main 2082 and is to be stored at a location on the phone 2092. Each of the other entries in the data list are comprised of similar fields which make up complete records.

Looking now at FIG. 5, the user prompt screen 2100 is shown. Recall that if the user failed to attach the apparatus of the present invention to an active USB port of the PC, the process prompts the user to do so by displaying the screen 2100. The only possible user action is to click on the OK box 2110. Once the user has acknowledged that the apparatus is missing, the application program quits. The user then properly attaches the apparatus to an active USB port on the PC and re-launches the program. The combination of the apparatus of the present invention, the method of the present invention and the data structure provide an efficient and easily implemented user solution to transferring data between a cell phone, a backup device such as the apparatus of the present invention and an editing device such as a PC.

As can been seen from the above discussion, the method and apparatus of the present invention provide the user with significant advantages over the existing art. These advantages include both economic savings and efficiency gains.

A first advantage of the present invention is the ability of a user to transfer data from and to a cell phone. Thus if the user wishes to change to a new phone, the data stored on the previous phone may be saved and transferred relieving the user of the need to reenter the data.

A second advantage of the present invention is the ability to backup the data stored in a cell phone to the apparatus of the present invention. Once stored within the memory of the apparatus of the present invention the user may simply leave it there for backup or, if desired, transfer the data to a PC for further manipulation or storage.

A third advantage of the present invention is the ability of a user to edit the contents of a cell phone memory in a user friendly data editing environment. Such an environment in a preferred embodiment is a PC. Having this ability allows the addition, deletion or modification of cell phone data without the clumsy and difficult mechanism provided by the limited function of the keypads of cell phones.

A fourth advantage of the present invention is the auto download upon launch of PC application. By accomplishing the transfer of data from the apparatus of the present invention to the temporary program memory of the PC resident application program, the data automatically populate the user screen making the operation efficient and user friendly.

1. A method for bidirectional transfer of data contained in a cellular phone memory to a target digital device for backup, update or modification, comprising:
attaching a cellular phone to a low complexity digital device apparatus, said cellular phone providing operational power to said low complexity digital device apparatus;
selecting one of a plurality of data transfer actions by depressing a button;
monitoring said low complexity digital device apparatus to determine when said selected one of said data transfer actions from said cellular phone is successful;
detaching said low complexity digital device apparatus from said cellular phone;
attaching said low complexity digital device apparatus to a target digital device, said target digital device providing power to said low complexity digital device apparatus;
launching an application program resident on said target digital device, said application program automatically retrieving said data transferred from said cellular phone;
selecting an action from among a plurality of actions possible from said application program said selected actions being from among add, edit or save;
completing said selected action;
detaching said low complexity digital device apparatus from said target digital device;
reattaching said cellular phone to a low complexity digital device apparatus, said cellular phone again providing operational power to said low complexity digital device apparatus;
reselecting one of a plurality of data transfer actions by depressing a button;
monitoring said low complexity digital device apparatus to determine when said reselected one of said data transfer actions from said cellular phone is successful, and;
redetaching said low complexity digital device apparatus from said cellular phone.

2. The method of claim 1 wherein the application program resident on the target digital device is menu driven.

3. The method of claim 1 wherein the application program resident of the target digital device is Windows™ operating system compatible.

4. The method of claim 1 wherein the target digital device is a personal computer.

5. The method of claim 1 wherein the low complexity digital device functions include at least Update and Backup.

6. The method of claim 1 wherein the target digital device application program functions include at least those of add, save and edit.

7. An apparatus for bidirectional transfer of data contained in a cellular phone memory to a target digital device for backup, update or modification, comprising:
a non-powered low complexity digital device further comprised of:
a central processing unit;
a memory;
two input/output ports, the first of said input/output ports configured to accommodate a target digital device interface connection, the second of said input/output ports configured to accept one of a plurality of manufacturer's characteristic adapters said manufacturer's characteristic adapters providing mechanical and electrical interface between said non-powered low complexity digital device and a cellular telephone, and each of said input/output ports providing power to said low complexity digital device upon connection of said input/output port;
a resident software program in said memory of said low complexity digital device, said resident software program capable of transferring data to and from a cellular telephone to said memory of low complexity digital device via said second input/output port upon user activation of functions provided by said resident software program, and;
an application software program resident on said target digital device said application software program capable of transferring data to and from said memory of said low complexity digital device to said target digital device via said first input/output port upon user selection of a plurality of functions provided by said application software program.

8. The apparatus of claim 7 wherein the target digital device is a personal computer.

9. The apparatus of claim 7 wherein the target digital device interface is USB.

10. The apparatus of claim 7 wherein the manufacturer's characteristic adapter is capable of interfacing to a Motorola cell phone.

11. The method of claim 1, the launching of the application program resident on the target digital device occurring automatically in response to the low complexity device being connected to the target digital device.

12. A computer readable medium storing thereon computer instructions, the computer instructions including at least an application software program, causing a processor to implement a method comprising:
in response to a low complexity device being connected to a target device, launching the application software program on the target digital device;
automatically, as a result of the launching, transferring data from a memory of the low complexity digital device to the target digital device.

13. The computer readable medium of claim 12, the method further including displaying on a monitor a window having the data.

14. The computer readable medium of claim 13, the window having the data displays the data as a series of one or more rows, each row having a name and a phone number associated with that name.

15. A system including at least a non-powered, low complexity digital device including at least an Inter-Device Transfer Processor (IDTP), the IDTP comprising:
a central processing unit (CPU);
a memory;
user controls,
two input/output ports,
a first of said two input/output ports being a device input/output that is configured to accommodate a target digital device interface connection,
a second of said two input/output ports being cell phone input/output port that is configured to accept one of a plurality of manufacturer's characteristic adapters said manufacturer's characteristic adapters providing mechanical and electrical interface between said non-powered low complexity digital device and a cellular telephone, and each of said input/output ports providing power to said low complexity digital device upon connection of said input/output port; and
a resident software program in said memory of said low complexity digital device, said resident software program including one or more instructions that cause a transferring of data from a cellular telephone to said memory of the low complexity digital device, via said second input/output port upon a user activation of functions provided by said resident software program.

16. The system of claim 15, further comprising a computer readable medium storing an application software program for said target digital device, said application software program, when implemented, causing a transferring of data between said memory of said low complexity digital device and said target digital device via said first input/output port upon a user selection of a plurality of functions provided by said application software program for said target digital device.

17. The system of claim 15, the memory storing at least a power up routine that is activated by plugging the low complexity digital device into the target device and that is activated by plugging the low complexity digital device into the cell phone.

18. The system of claim 15, the IDTP also including at least an address bus and a data bus; and
the address bus and the data bus communicatively connecting the user controls, the memory, and the CPU, such that the user controls, the memory, and the CPU communicate with one another via the address bus and the data bus.

19. The system of claim 15, the User Controls include at least an update button, and
a backup button;
the IDTP also including at least user indicators that include at least a series of one or more lights that inform the user of a status of various steps in a transfer process for transferring data from the IDTP to another device, including at least indicating a status of a transfer while the transfer is in progress.

20. The system of claim 15, the system further comprising a Manufacturer's Attribute Adapter (MAA) connected to the Cell Phone I/O; the MAA being connectable to a user's cell phone via a normal cell phone I/O connector.

21. The system of claim 15, the system further comprising a plurality of Manufacturer's Attribute Adapters (MAAs) each connectable to, and capable of communicating with, the Cell Phone I/O of a different type of cell phone; each of the MAAs being connectable to and capable of communicating with a user's cell phone via a normal cell phone I/O connector, each MAA being connectable to and capable of communicating with, a different type of cell phone.

22. The system of claim 15, further comprising a target device having a USB connector.

23. The system of claim 15, further comprising a target device that is a computer, the computer storing a program for manipulating data transferred from a cell phone.

24. The system of claim 15, in response to a loss of power resulting from unplugging the IDTP from a cell phone or target device, the IDTP being configured to
sense the loss of power, and
in response to the sensing of the loss of power, automatically shutdown system functions in an orderly fashion.

25. The system of claim 15, the IDTP implementing a method comprising:
performing a self diagnostics and power on setup routine, which verifies
that functions are capable of being performed, and
that error conditions do not exist.

26. The system of claim 15, the IDTP implementing a method comprising:
after the performing of the self diagnostic and power on setup routine, checking whether the IDTP has been unplugged;
if the IDTP is not unplugged, checking whether a button is pressed; and
if the IDTP is unplugged, automatically shutting down system functions in an orderly fashion.

27. The system of claim 15, the IDTP implementing a method comprising:
determining whether a download button was pressed;
if it is determined that the download button was pressed,
performing a setup auto download routine, which configures the IDTP for downloading data,
downloading data from the cell phone; and
checking whether the downloading was successful.

28. The system of claim 15, the IDTP implementing a method comprising:
displaying a blinking light to indicate that a transfer is in progress.

29. The system of claim 15, the IDTP implementing a method comprising:
if it was determined that a transfer was successful,
returning to checking whether the IDTP is unplugged.

30. The system of claim 15, the IDTP implementing a method comprising: if it was determined that a transfer was successful displaying a solid green light.

31. The system of claim 15, the IDTP implementing a method comprising:
determining whether an upload button was pressed;
if it is determined that the upload button was pressed,
performing a setup auto upload routine, which configures the IDTP for uploading data,
uploading data to the cell phone; and
checking whether the transfer was successful.

32. The system of claim 15, the IDTP implementing a method comprising if a transfer was not successful, displaying a red light.

33. The system of claim 15, the IDTP implementing a method comprising if a transfer was not successful, terminating the method.

34. The system of claim 15, the IDTP implementing a method comprising:
connecting an IDTP to a device;
performing a self diagnostics and power on setup routine, which verifies that functions are capable of being performed and that error conditions do not exist;
checking whether the IDTP has been unplugged;
if the IDTP is unplugged, automatically shutting down system functions in an orderly fashion;
if the IDTP is not unplugged, checking whether a button is pressed,
determining whether a download button was pressed;
if it is determined that the download button was pressed,
performing a setup auto download routine, which configures the IDTP for downloading the data,
downloading the data from the cell phone, and
checking whether the downloading was successful;
determining whether an upload button was pressed;
if it is determined that the upload button was pressed,
performing a setup auto upload routine, which configures the IDTP for uploading the data,
uploading the data from the cell phone,
displaying a blinking green light indicating that the uploading is occurring, and
checking whether the uploading was successful;
if the uploading was successful or if the downloading was successful,
displaying a solid green light indicating that the uploading was successful, and
returning to the checking of whether the IDTP is unplugged;
if the uploading was not successful or if the downloading was not successful,
displaying a solid red light indicating that the uploading was successful, and
terminating the method.

35. A method comprising:
attaching a cellular phone to a low complexity digital device apparatus, said cellular phone providing operational power to said low complexity digital device apparatus;
selecting one of a plurality of data transfer actions by depressing a button;
monitoring said low complexity digital device apparatus to determine when said selected one of said data transfer actions from said cellular phone is successful;
detaching said low complexity digital device apparatus from said cellular phone;
attaching said low complexity digital device apparatus to a target digital device, said target digital device providing power to said low complexity digital device apparatus;
launching a session with said target digital device, the launching of the session results in automatically retrieving said data transferred from said cellular phone;
selecting an action from among a plurality of actions possible from said application program said action being selected from among upload and download;
completing said selected action;
detaching said low complexity digital device apparatus from said target digital device;
reattaching said cellular phone to a low complexity digital device apparatus, said cellular phone again providing operational power to said low complexity digital device apparatus;
reselecting one of a plurality of data transfer actions by depressing a button;
monitoring said low complexity digital device apparatus to determine when said reselected one of said data transfer actions from said cellular phone is successful, and;
redetaching said low complexity digital device apparatus from said cellular phone.
